(19) United States
(12) Patent Application Publication
(10) Pub. No.: US 2026/0265058 A1
(43) Pub. Date: Sep. 10, 2026

(54) PREPARATION METHOD FOR LITHIUM IRON PHOSPHATE MATERIAL, LITHIUM IRON PHOSPHATE MATERIAL AND USE THEREOF

(71) Applicant: LBM NEW ENERGY (AP) PTE. LTD., Singapore (SG)

(72) Inventors: Wei SHAO, Singapore (SG); Yingfei SHI, Singapore (SG); Jing FANG, Singapore (SG); Maomao CHEN, Singapore (SG); Junfeng SHI, Singapore (SG)

(73) Assignee: LBM NEW ENERGY (AP) PTE. LTD., Singapore (SG)

(21) Appl. No.: 19/133,513

(22) PCT Filed: Feb. 21, 2025
(86) PCT No.: PCT/SG2025/050124

§ 371 Date: May 28, 2025

(30) Foreign Application Priority Data
Jan. 20, 2025 (SG) 10202500160V

(51) Int. Cl. C01B 25/45; H01M 4/136; H01M 4/58; H01M 10/052

(52) U.S. Cl. CPC C01B 25/45; H01M 4/136; H01M 4/5825; H01M 10/052; C01P 2004/03; C01P 2004/51; C01P 2004/61; C01P 2004/62; C01P 2006/10; C01P 2006/11; C01P 2006/12; C01P 2006/40

(57) ABSTRACT

Provided are a preparation method for a lithium iron phosphate material, a lithium iron phosphate material and use thereof. The preparation method for a lithium iron phosphate material includes steps of: (a) performing grinding treatment on lithium source, iron source, phosphorus source, carbon source, fluxing material and solvent, so as to render mixed slurry, ratio of total mass of iron source and the phosphorus source to mass of fluxing material being 1:(0.001-0.015); (b) performing spray drying on mixed slurry, nozzle for spray drying including two-fluid nozzle, so as to render first material; and (c) performing thermal treatment on first material, where thermal treatment includes first constant-temperature treatment and second constant-temperature treatment, temperature T1 of first constant-temperature treatment ranges from 450° C. to 650° C., and temperature T2 of second constant-temperature treatment ranges from 650° C. to 850° C.

The present disclosure claims the priority to the Singaporean patent application with the filing No. 10202500160V filed on Jan. 20, 2025 with the Singaporean Patent Office, and entitled “PREPARATION METHOD FOR LITHIUM IRON PHOSPHATE MATERIAL, LITHIUM IRON PHOSPHATE MATERIAL AND USE THEREOF”, the contents of which are incorporated herein by reference in entirety.

### TECHNICAL FIELD

The present disclosure relates to the technical field of batteries, and specifically to a preparation method for a lithium iron phosphate material, a lithium iron phosphate material and use thereof.

### BACKGROUND ART

With the rapid development of new energy vehicle industry, the power battery industry is growing rapidly. Lithium iron phosphate, as a positive electrode material of a lithium-ion battery, has gradually become a hotspot for research and application due to its characteristics such as rich resources, low price, good cycle stability, stability to electrolytic solution at a high temperature and stable discharge voltage platform. Spherical lithium iron phosphate is considered as one of the effective ways to improve performance of lithium iron phosphate material due to its advantages such as regular particle shape, high tap density, and facilitating penetration of electrolytic solution and diffusion of lithium ions. However, the lithium iron phosphate material obtained by the conventional preparation method has problems of low compaction density, poor particle strength, non-uniform particle dimension distribution, and unsuitable specific surface area.

Therefore, how to provide a lithium iron phosphate material having a high compaction density, a high tap density, and a suitable specific surface area is crucial to the development of batteries.

### SUMMARY

The present disclosure provides a preparation method for a lithium iron phosphate material, including steps of:
(a) performing a grinding treatment on a lithium source, an iron source, a phosphorus source, a carbon source, a fluxing material and a solvent, so as to render a mixed slurry, where a ratio of a total mass of the iron source and the phosphorus source to a mass of the fluxing material is 1:(0.001-0.015);
(b) performing spray drying on the mixed slurry, where a nozzle for the spray drying includes a two-fluid nozzle, and the spray drying is performed at a spray temperature ranging from 180° C. to 300° C., a spray pressure ranging from 0.1 MPa to 0.8 MPa, and a feeding frequency ranging from 20 Hz to 50 Hz, so as to render a first material; and
(c) performing a thermal treatment on the first material, where the thermal treatment includes a first constant-temperature treatment and a second constant-temperature treatment, a temperature T1 of the first constant-temperature treatment ranges from 450° C. to 650° C., and a temperature T2 of the second constant-temperature treatment ranges from 650° C. to 850° C.

In some embodiments, the fluxing material includes at least one of boric acid, calcium oxide and magnesium oxide.

In some embodiments, a ratio of a total mass of the iron source and the phosphorus source to a mass of the fluxing material is 1:(0.002-0.01).

In some embodiments, the fluxing material includes a material A and a material B, where the material A is boric acid, the material B is calcium oxide and/or magnesium oxide, and a mass ratio of the material A to the material B is (7-9):(1-3).

In some embodiments, a molar ratio of the lithium source, the iron source and the phosphorous source, in terms of lithium element, iron element and phosphorous element, respectively, is (1-1.08):(0.95-1):(0.95-1).

In some embodiments, a ratio of the total mass of the iron source and the phosphorus source to a mass of the carbon source is 1:(0.03-0.15).

In some embodiments, the carbon source includes at least one of sucrose, glucose, starch, carbon black, polyethylene glycol and phenolic resin.

In some embodiments, the spray temperature of the spray drying ranges from 200° C. to 260° C., the spray pressure ranges from 0.4 MPa to 0.6 MPa, and the feeding frequency ranges from 30 Hz to 45 Hz.

In some embodiments, a difference between the temperature T2 of the second constant-temperature treatment and the temperature T1 of the first constant-temperature treatment meets: 180° C.≤T2−T1≤250° C.

In some embodiments, a duration of the first constant-temperature treatment ranges from 2 h to 10 h.

In some embodiments, a duration of the second constant-temperature treatment ranges from 2 h to 10 h.

In some embodiments, a heating rate of the thermal treatment ranges from 0.5° C./min to 10° C./min.

In some embodiments, the thermal treatment is performed under a condition of protective gas.

In some embodiments, the temperature of the first constant-temperature treatment ranges from 500° C. to 600° C., and the duration of the first constant-temperature treatment ranges from 3 h to 8 h. The temperature of the second constant-temperature treatment ranges from 700° C. to 800° C., and the duration of the second constant-temperature treatment ranges from 4 h to 8 h.

In some embodiments, the grinding treatment includes a first grinding and a second grinding, where a rotational speed R1 of the first grinding ranges from 300 r/min to 400 r/min, a rotational speed R2 of the second grinding ranges from 500 r/min to 700 r/min, and a ratio of the rotational speed R1 of the first grinding to the rotational speed R2 of the second grinding meets: 1.25≤R1/R2≤2. A duration of the first grinding ranges from 0.5 h to 4 h; and a duration of the second grinding ranges from 0.5 h to 6 h.

In some embodiments, the mixed slurry has a solid content ranging from 20% to 60%.

In some embodiments, the mixed slurry has a particle size D50 ranging from 200 nm to 400 nm.

In some embodiments, the preparation method for a lithium iron phosphate material further includes: performing a sieving treatment on a material having undergone the thermal treatment, where a mesh number of the sieving treatment ranges from 180 mesh to 250 mesh.

Provided is a lithium iron phosphate material, prepared by the preparation method for a lithium iron phosphate material.

In some embodiments, the lithium iron phosphate material has a compaction density ranging from 2.36 g/cm³ to 2.55 g/cm³.

In some embodiments, the lithium iron phosphate material has a tap density ranging from 1.82 g/cm³ to 2.2 g/cm³.

In some embodiments, the lithium iron phosphate material has a particle size D50 ranging from 8.6 μm to 11 μm.

In some embodiments, the lithium iron phosphate material has a specific surface area ranging from 5 m²/g to 8 m²/g.

In some embodiments, the lithium iron phosphate material has resistivity ranging from 10 Ω·cm to 39.1 Ω·cm.

In some embodiments, the lithium iron phosphate material has particle strength ranging from 72 MPa to 160 MPa.

Provided is an electrode plate, including the lithium iron phosphate material prepared by the preparation method for a lithium iron phosphate material, or the lithium iron phosphate material.

Provided is a battery, including the electrode plate.

Provided is an electrical device, including the battery.

### BRIEF DESCRIPTION OF DRAWINGS

In order to more clearly illustrate technical solutions of embodiments of the present disclosure, drawings which need to be used in the embodiments will be briefly introduced below. It should be understood that the following drawings only exemplify the embodiments of the present disclosure, dimensional proportions in the drawings do not directly correspond to true proportions in the embodiments, and at the same time, the following drawings only show some embodiments of the present disclosure, and thus should not be regarded as limitation to the scope.

FIG. 1 is a scanning electron microscope image of a lithium iron phosphate material in Example 1;

FIG. 2 is a CP image of the lithium iron phosphate material in Example 1;

FIG. 3 shows comparison images of the lithium iron phosphate material in Example 1 before and after a particle strength test;

FIG. 4 is a scanning electron microscope image of a lithium iron phosphate material in Example 2;

FIG. 5 is a scanning electron microscope image of a lithium iron phosphate material in Comparative Example 1;

FIG. 6 is a scanning electron microscope image of a lithium iron phosphate material in Comparative Example 3; and

FIG. 7 is a scanning electron microscope image of a lithium iron phosphate material in Comparative Example 5.

### DETAILED DESCRIPTION OF EMBODIMENTS

Advantages of the embodiments of the present disclosure in SUMMARY will be partially set forth in the following DETAILED DESCRIPTION OF EMBODIMENTS of the description, and partially obvious according to the description, or may be learned by part of the embodiments of the present disclosure.

The technical solutions of the present disclosure will be further described below in conjunction with drawings and through some embodiments.

In order to make objectives, technical solutions and advantages of the present disclosure more clear and understandable, the present disclosure will be further described in detail below in conjunction with the drawings and embodiments. It should be understood that the embodiments described herein are merely illustrative of the present disclosure and are not intended to limit the present disclosure. Besides, technical features involved in various embodiments of the present disclosure described below may be combined with each other as long as they do not conflict with each other. Without departing from the principle of the embodiments of the present disclosure, improvements and modifications could also be made, and all of these improvements and modifications are also regarded as the scope of protection of the embodiments of the present disclosure.

According to an aspect of the present disclosure, the present disclosure relates to a preparation method for a lithium iron phosphate material, including steps as follows:
(a) performing a grinding treatment on a lithium source, an iron source, a phosphorus source, a carbon source, a fluxing material and a solvent, so as to render a mixed slurry, where a ratio of a total mass of the iron source and the phosphorus source to a mass of the fluxing material is 1:(0.001-0.015);
(b) performing spray drying on the mixed slurry, where a nozzle for the spray drying includes a two-fluid nozzle, and the spray drying is performed at a spray temperature ranging from 180° C. to 300° C., a spray pressure ranging from 0.1 MPa to 0.8 MPa, and a feeding frequency ranging from 20 Hz to 50 Hz, so as to render a first material; and
(c) performing a thermal treatment on the first material, where the thermal treatment includes a first constant-temperature treatment and a second constant-temperature treatment, a temperature T1 of the first constant-temperature treatment ranges from 450° C. to 650° C., and a temperature T2 of the second constant-temperature treatment ranges from 650° C. to 850° C.

The preparation method for a lithium iron phosphate material of the present disclosure can solve the problems of low compaction density, poor particle strength, non-uniform particle dimension distribution, and unsuitable specific surface area existing in the lithium iron phosphate material prepared by the conventional method. The present disclosure uses a suitable amount of the fluxing material, which facilitates melting of spheres, and enhances particle strength inside the spheres; and further uses the two-fluid nozzle to perform the spray drying, and controls the temperature, pressure and feeding frequency to meet certain conditions, so that the performance of the first material can be optimized. On the basis of the fluxing material and the drying with the two-fluid nozzle, under suitable thermal treatment conditions, the first constant-temperature treatment at a low temperature can optimize carbon coating, and makes the reaction more sufficient, and the second constant-temperature treatment at a high temperature is beneficial to further optimizing the compaction density and particle strength of the material, so as to obtain a suitable specific surface area. In the present disclosure, by adding the suitable fluxing material into the raw materials, with suitable spray drying conditions and thermal treatment conditions, and coordination of various steps and parameter conditions, the obtained lithium iron phosphate material is further enabled to obtain a high compaction density, a high tap density, high particle strength, good conductivity, and good structural stability, and thus processability and electrochemical performance of the material can be improved.

In some embodiments, the fluxing material includes one or a combination of more of boric acid, calcium oxide and magnesium oxide, such as boric acid and calcium oxide, boric acid and magnesium oxide. In some embodiments, the fluxing material includes a material A and a material B, where the material A is boric acid, the material B is calcium oxide and/or magnesium oxide, and a mass ratio of the material A to the material B is (7-9):(1-3), so that the material A and the material B in a suitable mass ratio can better synergistically play a role and improve a fluxing effect. In some embodiments, a ratio of a total mass of the iron source and the phosphorus source to a mass of the fluxing material is, for example, 1:0.001, 1:0.002, 1:0.005, 1:0.008, 1:0.009, 1:0.01, 1:0.011, 1:0.012, and 1:0.015, etc. In some embodiments, the ratio of the total mass of the iron source and the phosphorus source to the mass of the fluxing material is 1:(0.002-0.01). The fluxing material in the present disclosure needs to be used in a suitable amount ratio, where a too low amount ratio leads to an insignificant fluxing effect and unsatisfactory improvement on the performance of the material, and a too high amount of the fluxing material used not only causes wastes, but also affects exertion of performance of the material. In the present disclosure, by adding into the raw materials the fluxing material in a suitable amount ratio, with the spray drying under suitable conditions, it is conducive to melting of material particles during the thermal treatment, enhancing the strength of particles inside the material, and improving the processability and electrochemical performance of the lithium iron phosphate material.

In some embodiments, a molar ratio of the lithium source, the iron source and the phosphorous source, in terms of lithium element, iron element and phosphorous element, respectively, is (1-1.08):(0.95-1):(0.95-1), for example, 1:0.95:0.95, 1.05:0.97:0.97, and 1.06:1:1. In some embodiments, the lithium source includes one or more of lithium carbonate, lithium hydroxide and lithium nitrate. The iron source includes one or more of iron oxide, iron phosphate, iron sesquioxide and ferrous oxalate. The phosphorus source includes one or more of phosphoric acid, iron phosphate, and ammonium dihydrogen phosphate.

In some embodiments, a ratio of the total mass of the iron source and the phosphorus source to a mass of the carbon source is 1:(0.03-0.15), for example, 1:0.05, 1:0.07, 1:0.09, 1:0.11, 1:0.13 and 1:0.15. The present disclosure can form, with the carbon source in a suitable amount ratio, a carbon coating layer with a uniform thickness on a surface of the lithium iron phosphate material, which is beneficial to improving the electrochemical performance of the material. In some embodiments, the carbon source includes one or a combination of more of sucrose, glucose, starch, carbon black, polyethylene glycol and phenolic resin, for example, a combination of sucrose and glucose, a combination of carbon black and polyethylene glycol, and a combination of carbon black, polyethylene glycol and phenolic resin. In some embodiments, a mass ratio of sucrose to glucose is (0.5-1):(1-2).

In some embodiments, the grinding treatment includes a first grinding and a second grinding. The first grinding is ball milling, and the second grinding is sand milling. A rotational speed R1 of the first grinding ranges from 300 r/min to 400 r/min, including but not limited to 300 r/min, 320 r/min, 350 r/min, 370 r/min, 400 r/min, etc., or a value within a range between any two. A rotational speed R2 of the second grinding ranges from 500 r/min to 700 r/min, including but not limited to 500 r/min, 530 r/min, 550 r/min, 580 r/min, 600 r/min, 620 r/min, 650 r/min or 700 r/min, etc., or a value within a range between any two. A ratio of the rotational speed R1 of the first grinding to the rotational speed R2 of the second grinding meets: 1.25≤R1/R2≤2, for example, 1.25, 1.3, 1.4, 1.5, 1.6, 1.7, 1.8, 1.9, and 2, or a value within a range between any two. The first grinding lasts for 0.5 h to 4 h, for example, 0.5 h, 1 h, 1.5 h, 2 h, 2.5 h, 3 h, 3.5 h, and 4 h. The second grinding lasts for 0.5 h to 6 h, for example, 0.5 h, 1 h, 1.5 h, 2 h, 2.5 h, 3 h, 3.5 h, 4 h, 5 h, and 6 h. The present disclosure uses the suitable first grinding and second grinding, and limits the ratio of the rotational speed R1 of the first grinding to the rotational speed R2 of the second grinding to meet a suitable condition, so that through coordination of the two, the material can be ensured to be sufficiently ground, so as to render an uniformly dispersed mixed slurry with a suitable particle size and a suitable solid content.

In some embodiments, the mixed slurry has the solid content ranging from 20% to 60%, including but not limited to 20%, 25%, 30%, 35%, 40%, 45%, 55%, 60%, etc., or a value within a range between any two. In some embodiments, the mixed slurry has a particle size D50 ranging from 200 nm to 400 nm, including but not limited to 200 nm, 250 nm, 280 nm, 300 nm, 320 nm, 350 nm, 370 nm, 400 nm, etc., or a value within a range between any two. The mixed slurry in the present disclosure has a suitable solid content and a suitable material particle size, which is beneficial to subsequent spray drying treatment.

The spray drying in the present disclosure uses the two-fluid nozzle. The two-fluid nozzle sprays very fine mist, so as to be conducive to physicochemical properties of the first material, enable the material to be compact inside, reduce generation of pores, and make a structural frame more stable, and it is less likely to cause a phenomenon of collapse or fall off during preparation of an electrode plate. In some embodiments, the spray temperature of the spray drying ranges from 180° C. to 300° C., including but not limited to 180° C., 190° C., 200° C., 210° C., 220° C., 250° C., 280° C., 290° C., 300° C., etc., or a value within a range between any two. The spray pressure ranges from 0.1 MPa to 0.8 MPa, including but not limited to 0.1 MPa, 0.2 MPa, 0.3 MPa, 0.4 MPa, 0.5 MPa, 0.6 MPa, 0.7 MPa, 0.8 MPa, etc., or a value within a range between any two. The feeding frequency ranges from 20 Hz to 50 Hz, including but not limited to 20 Hz, 25 Hz, 30 Hz, 35 Hz, 40 Hz, 45 Hz, or 50 Hz, etc., or a value within a range between any two. In some embodiments, the spray temperature of the spray drying ranges from 200° C. to 260° C., the spray pressure ranges from 0.4 MPa to 0.6 MPa, and the feeding frequency ranges from 30 Hz to 45 Hz. By defining the temperature, pressure and feeding frequency of the spray drying to be within suitable ranges, the present disclosure can ensure compactness inside the material, reduce the pores, and improve the structural stability, which is more beneficial to improving the physicochemical properties of the first material. If the temperature, pressure and feeding frequency of the spray drying do not meet the above conditions, the stability of the first material will be affected, causing deteriorated strength of a final lithium iron phosphate material, and reduced electrochemical performance.

In some embodiments, a difference between the temperature T2 of the second constant-temperature treatment and the temperature T1 of the first constant-temperature treatment meets: 180° C.≤T2−T1≤250° C.; and the difference T2-T1 between the temperature T2 of the second constant-temperature treatment and the temperature T1 of the first constant-temperature treatment is 180° C., 190° C., 200° C., 220° C., 230° C., 250° C., etc. In the present disclosure, the difference between the temperature T2 of the second constant-temperature treatment and the temperature T1 of the first constant-temperature treatment is within a suitable range, which is more beneficial to improving the compaction density and tap density of the finally obtained lithium iron phosphate material, the particle strength is high, and the specific surface area is suitable. The temperature of the first constant-temperature treatment ranges from 450° C. to 650° C., including but not limited to 450° C., 480° C., 500° C., 510° C., 520° C., 550° C., 580° C., 600° C., 620° C., 650° C., etc., or a value within a range between any two. The first constant-temperature treatment lasts for 2 h to 10 h, including but not limited to 2 h, 3 h, 4 h, 5 h, 6 h, 7 h, 8 h, 9 h, 10 h, etc., or a value within a range between any two. The temperature of the second constant-temperature treatment ranges from 650° C. to 850° C., including but not limited to 650° C., 680° C., 700° C., 720° C., 750° C., 780° C., 800° C., 820° C., 850° C., etc., or a value within a range between any two. The second constant-temperature treatment lasts for 2 h to 10 h, including but not limited to 2 h, 3 h, 4 h, 5 h, 6 h, 7 h, 8 h, 9 h, 10 h, etc., or a value within a range between any two. The temperature of the first constant-temperature treatment ranges from 500° C. to 600° C., and the first constant-temperature treatment lasts for 3 h to 8 h; the temperature of the second constant-temperature treatment ranges from 700° C. to 800° C., and the second constant-temperature treatment lasts for 4 h to 8 h. In some embodiments, a heating rate in the thermal treatment process ranges from 0.5° C./min to 10° C./min, including but not limited to 0.5° C./min, 1° C./min, 2° C./min, 3° C./min, 5° C./min, 6° C./min, 7° C./min, 8° C./min, 10° C./min, etc. In some embodiments, the heating rate in the thermal treatment process ranges from 1.5° C./min to 8° C./min. In some embodiments, the thermal treatment is performed under a condition of protective gas, such as nitrogen, argon, and helium. In the present disclosure, the suitable first constant-temperature treatment is used, so as to facilitate carbon coating, and make reaction more sufficient, and the suitable second constant-temperature treatment is used, which can further improve the strength of material, obtain a suitable specific surface area, and provide good conductivity. If one constant-temperature treatment or two constant-temperature treatments used do not meet the above conditions, the particle strength of the finally obtained lithium iron phosphate material will be affected, and thus the processability and electrochemical performance thereof will be affected.

In some embodiments, the preparation method for a lithium iron phosphate material further includes: performing a sieving treatment on the material having undergone the thermal treatment, so as to render the lithium iron phosphate material with a suitable particle size. A mesh number of the sieving treatment ranges from 180 mesh to 250 mesh, for example, 180 mesh, 200 mesh, 220 mesh, 250 mesh, etc. or a value within a range between any two.

According to another aspect of the present disclosure, the present disclosure further relates to a lithium iron phosphate material, prepared by the preparation method for a lithium iron phosphate material.

The lithium iron phosphate material of the present disclosure has a high compaction density, high strength, a suitable specific surface area, high specific conductance, good processability, and excellent electrochemical performance.

In some embodiments, the compaction density of the lithium iron phosphate material ranges from 2.36 g/cm³ to 2.55 g/cm³, including but not limited to 2.4 g/cm³, 2.45 g/cm³, 2.5 g/cm³, 2.52 g/cm³, 2.55 g/cm³, etc. In some embodiments, a tap density of the lithium iron phosphate material ranges from 1.82 g/cm³ to 2.2 g/cm³, including but not limited to 1.9 g/cm³, 1.95 g/cm³, 2 g/cm³, 2.1 g/cm³, 2.2 g/cm³, etc. In some embodiments, a particle size D50 of the lithium iron phosphate material ranges from 8.6 μm to 11 μm, for example, 8.6 μm, 8.8 μm, 9 μm, 9.5 μm, 10 μm, 10.5 μm, or 11 μm. In some embodiments, the specific surface area of the lithium iron phosphate material ranges from 5 m²/g to 8 m²/g, for example, 5 m²/g, 5.2 m²/g, 5.5 m²/g, 5.8 m²/g, 6 m²/g, 6.2 m²/g, 6.5 m²/g, etc. In some embodiments, resistivity of the lithium iron phosphate material ranges from 10 Ω·cm to 39.1 Ω·cm, for example, 10 Ω·cm, 12 Ω·cm, 15 Ω·cm, 16 Ω·cm, 17 Ω·cm, 20 Ω·cm, 21.5 Ω·cm, etc. In some embodiments, the particle strength of the lithium iron phosphate material ranges from 72 MPa to 160 MPa, for example, 100 MPa, 110 MPa, 120 MPa, 130 MPa, 140 MPa, 150 MPa, 160 MPa, etc.

According to another aspect of the present disclosure, the present disclosure further relates to an electrode plate, including the lithium iron phosphate material prepared by the above preparation method for a lithium iron phosphate material, or the above lithium iron phosphate material.

In some embodiments, the electrode plate includes a positive electrode current collector and a positive electrode layer located on at least one side surface of the positive electrode current collector, where the positive electrode layer includes the above lithium iron phosphate material, a binder and a conductive agent. In some embodiments, a mass content of the lithium iron phosphate material in the positive electrode layer ranges from 88% to 95%.

According to another aspect of the present disclosure, the present disclosure further relates to a battery, including the above electrode plate.

The battery of the present disclosure has high specific capacity, high Coulombic efficiency, and excellent cycle performance and safety performance.

In some embodiments, the battery includes the above electrode plate, a negative electrode plate, a separator and an electrolytic solution.

According to another aspect of the present disclosure, the present disclosure further relates to an electrical device, including the above battery. The electrical device includes tablet computer, notebook computer, electric vehicle, electric tool, and so on.

Further illustration is given below in conjunction with specific examples.

### Example 1

A preparation method for a lithium iron phosphate material was provided, including steps as follows:
(1) uniformly mixing lithium carbonate, iron phosphate, a carbon source (sucrose and glucose), a fluxing material (boric acid) and water, with Li in lithium source and Fe in iron source being weighed in a molar ratio of 1.05:0.97, a mass ratio of the carbon source to iron phosphate being 0.1:1, a weight ratio of sucrose to glucose being 1:1, and a mass ratio of boric acid to iron phosphate being 0.003:1, so as to render a mixed system;
(2) performing a first grinding on the above mixed system, the first grinding being ball milling at a rotational speed of 350 r/min for 1 h, so as to render a primary ball-milled slurry; transferring the resulting ball-milled slurry into a sand mill for further sufficient grinding, performing sand milling at a rotational speed of 600 r/min for 70 min, controlling a solid content of the slurry to be 40%, and controlling a particle size D50 of sand-milled particles to be 350 nm, so as to render a sand-milled slurry;
(3) transferring the resulting sand-milled slurry to a spray column for precursor spray granulation, a spray temperature being 260° C., selecting a two-fluid nozzle as a spray nozzle, controlling a spray pressure to be 0.5 MPa, and controlling a feeding frequency to be 35 Hz, so as to render a spray precursor of primary spherical particles; and
(4) loading the resulting spray precursor in a bowl, performing a thermal treatment in a nitrogen atmosphere, the thermal treatment including a first constant-temperature treatment and a second constant-temperature treatment, controlling a heating rate of a box type furnace to be 2.5° C./min, performing the first constant-temperature treatment at a temperature of 550° C. for a constant-temperature treatment duration of 6 h, performing the second constant-temperature treatment at a temperature of 760° C. for a constant-temperature treatment duration of 4 h, so as to render a sintered finished material, and sieving the finished material through a 200-mesh sieve, so as to render the lithium iron phosphate material.

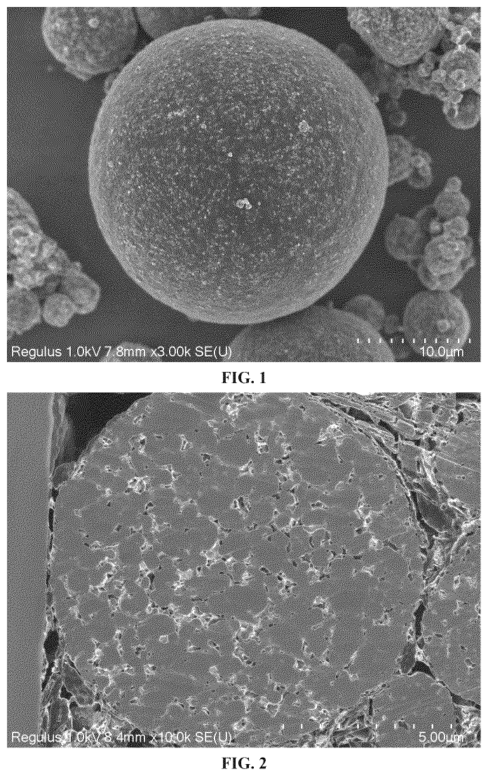

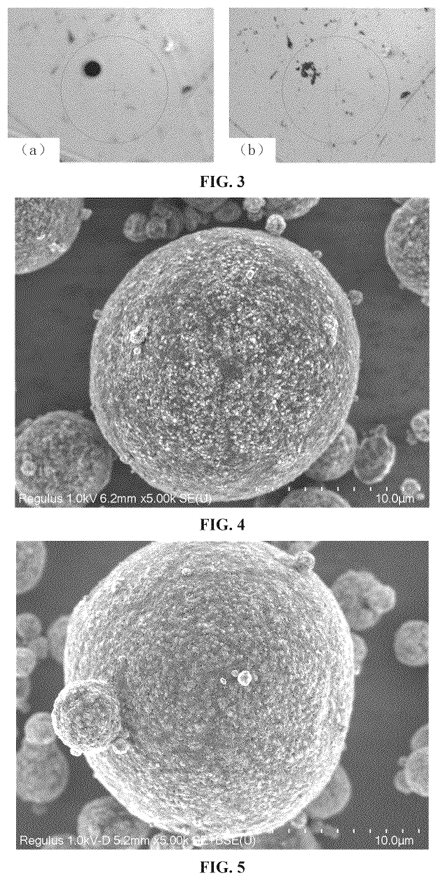

A scanning electron microscope image of the lithium iron phosphate material in the present example is as shown in FIG. 1; and a CP image of the lithium iron phosphate material is as shown in FIG. 2. Comparison images of the lithium iron phosphate material before and after a particle strength test are as shown in FIG. 3, where (a) is an image before test, and (b) is an image after test.

### Example 2

A preparation method for a lithium iron phosphate material was provided, including steps as follows:
(1) uniformly mixing lithium carbonate, iron phosphate, a carbon source (sucrose and glucose), a fluxing material (boric acid) and water, with Li in lithium source and Fe in iron source being weighed in a molar ratio of 1.05:0.97, a mass ratio of the carbon source to iron phosphate being 0.1:1, a weight ratio of sucrose to glucose being 1:1, and a mass ratio of boric acid to iron phosphate being 0.003:1, so as to render a mixed system;
(2) performing a first grinding on the above mixed system, the first grinding being ball milling at a rotational speed of 400 r/min for 1 h, so as to render a primary ball-milled slurry; transferring the resulting ball-milled slurry into a sand mill for further sufficient grinding, performing sand milling at a rotational speed of 650 r/min for 70 min, controlling a solid content of the slurry to be 40%, and controlling a particle size D50 of sand-milled particles to be 350 nm, so as to render a sand-milled slurry;
(3) transferring the resulting sand-milled slurry to a spray column for precursor spray granulation, a spray temperature being 220° C., selecting a two-fluid nozzle as a spray nozzle, controlling a spray pressure to be 0.4 MPa, and controlling a feeding frequency to be 32 Hz, so as to render a spray precursor of primary spherical particles; and
(4) loading the resulting spray precursor in a bowl, performing a thermal treatment in a nitrogen atmosphere, the thermal treatment including a first constant-temperature treatment and a second constant-temperature treatment, controlling a heating rate of a box type furnace to be 2.5° C./min, performing the first constant-temperature treatment at a temperature of 550° C. for a constant-temperature treatment duration of 6 h, performing the second constant-temperature treatment at a temperature of 760° C. for a constant-temperature treatment duration of 4 h, so as to render a sintered finished material, and sieving the finished material through a 200-mesh sieve, so as to render the lithium iron phosphate material.

A scanning electron microscope image of the lithium iron phosphate material in the present example is as shown in FIG. 4.

### Example 3

A preparation method for a lithium iron phosphate material was provided, including steps as follows:
(1) uniformly mixing lithium carbonate, iron phosphate, a carbon source (sucrose and glucose), a fluxing material (boric acid) and water, with Li in lithium source and Fe in iron source being weighed in a molar ratio of 1.05:0.97, a mass ratio of the carbon source to iron phosphate being 0.1:1, a weight ratio of sucrose to glucose being 1:1, and a mass ratio of boric acid to iron phosphate being 0.003:1, so as to render a mixed system;
(2) performing a first grinding on the above mixed system, the first grinding being ball milling at a rotational speed of 300 r/min for 1.5 h, so as to render a primary ball-milled slurry; transferring the resulting ball-milled slurry into a sand mill for further sufficient grinding, performing sand milling at a rotational speed of 500 r/min for 1.5 h, controlling a solid content of the slurry to be 35%, and controlling a particle size D50 of sand-milled particles to be 330 nm, so as to render a sand-milled slurry;
(3) transferring the resulting sand-milled slurry to a spray column for precursor spray granulation, a spray temperature being 200° C., selecting a two-fluid nozzle as a spray nozzle, controlling a spray pressure to be 0.4 MPa, and controlling a feeding frequency to be 45 Hz, so as to render a spray precursor of primary spherical particles; and
(4) loading the resulting spray precursor in a bowl, performing a thermal treatment in a nitrogen atmosphere, the thermal treatment including a first constant-temperature treatment and a second constant-temperature treatment, controlling a heating rate of a box type furnace to be 5° C./min, performing the first constant-temperature treatment at a temperature of 600° C. for a constant-temperature treatment duration of 5 h, performing the second constant-temperature treatment at a temperature of 800° C. for a constant-temperature treatment duration of 3 h, so as to render a sintered finished material, and sieving the finished material through a 200-mesh sieve, so as to render the lithium iron phosphate material.

### Example 4

A preparation method for a lithium iron phosphate material was provided, including steps as follows:
(1) uniformly mixing lithium carbonate, iron phosphate, a carbon source (sucrose and glucose), a fluxing material (boric acid) and water, with Li in lithium source and Fe in iron source being weighed in a molar ratio of 1.05:0.97, a mass ratio of the carbon source to iron phosphate being 0.1:1, a weight ratio of sucrose to glucose being 1:1, and a mass ratio of boric acid to iron phosphate being 0.003:1, so as to render a mixed system;
(2) performing a first grinding on the above mixed system, the first grinding being ball milling at a rotational speed of 550 r/min for 1.5 h, so as to render a primary ball-milled slurry; transferring the resulting ball-milled slurry into a sand mill for further sufficient grinding, performing sand milling at a rotational speed of 600 r/min for 1.5 h, controlling a solid content of the slurry to be 35%, and controlling a particle size D50 of sand-milled particles to be 330 nm, so as to render a sand-milled slurry;
(3) transferring the resulting sand-milled slurry to a spray column for precursor spray granulation, a spray temperature being 260° C., selecting a two-fluid nozzle as a spray nozzle, controlling a spray pressure to be 0.6 MPa, and controlling a feeding frequency to be 30 Hz, so as to render a spray precursor of primary spherical particles; and
(4) loading the resulting spray precursor in a bowl, performing a thermal treatment in a nitrogen atmosphere, the thermal treatment including a first constant-temperature treatment and a second constant-temperature treatment, controlling a heating rate of a box type furnace to be 5° C./min, performing the first constant-temperature treatment at a temperature of 500° C. for a constant-temperature treatment duration of 8 h, performing the second constant-temperature treatment at a temperature of 700° C. for a constant-temperature treatment duration of 8 h, so as to render a sintered finished material, and sieving the finished material through a 200-mesh sieve, so as to render the lithium iron phosphate material.

### Example 5

A preparation method for a lithium iron phosphate material was provided, including steps as follows:
(1) uniformly mixing lithium carbonate, iron phosphate, a carbon source (sucrose and glucose), a fluxing material and water, with Li in lithium source and Fe in iron source being weighed in a molar ratio of 1.05:0.97, a mass ratio of the carbon source to iron phosphate being 0.1:1, a weight ratio of sucrose to glucose being 1:1, the fluxing material being boric acid, calcium oxide and magnesium oxide in a mass ratio of 8:1:1, and a mass ratio of the fluxing material to iron phosphate being 0.005:1, so as to render a mixed system;
(2) performing a first grinding on the above mixed system, the first grinding being ball milling at a rotational speed of 380 r/min for 1.5 h, so as to render a primary ball-milled slurry; transferring the resulting ball-milled slurry into a sand mill for further sufficient grinding, performing sand milling at a rotational speed of 620 r/min for 1.5 h, controlling a solid content of the slurry to be 35%, and controlling a particle size D50 of sand-milled particles to be 330 nm, so as to render a sand-milled slurry;
(3) transferring the resulting sand-milled slurry to a spray column for precursor spray granulation, a spray temperature being 240° C., selecting a two-fluid nozzle as a spray nozzle, controlling a spray pressure to be 0.5 MPa, and controlling a feeding frequency to be 40 Hz, so as to render a spray precursor of primary spherical particles; and
(4) loading the resulting spray precursor in a bowl, performing a thermal treatment in a nitrogen atmosphere, the thermal treatment including a first constant-temperature treatment and a second constant-temperature treatment, controlling a heating rate of a box type furnace to be 5° C./min, performing the first constant-temperature treatment at a temperature of 580° C. for a constant-temperature treatment duration of 5 h, performing the second constant-temperature treatment at a temperature of 780° C. for a constant-temperature treatment duration of 3 h, so as to render a sintered finished material, and sieving the finished material through a 200-mesh sieve, so as to render the lithium iron phosphate material.

### Example 6

A preparation method for a lithium iron phosphate material was provided, including steps as follows:
(1) uniformly mixing lithium carbonate, iron phosphate, a carbon source (sucrose and glucose), a fluxing material (boric acid) and water, with Li in lithium source and Fe in iron source being weighed in a molar ratio of 1.05:0.97, a mass ratio of the carbon source to iron phosphate being 0.1:1, a weight ratio of sucrose to glucose being 1:1, and a mass ratio of boric acid to iron phosphate being 0.01:1, so as to render a mixed system;
(2) performing a first grinding on the above mixed system, the first grinding being ball milling at a rotational speed of 300 r/min for 4 h, so as to render a primary ball-milled slurry; transferring the resulting ball-milled slurry into a sand mill for further sufficient grinding, performing sand milling at a rotational speed of 500 r/min for 6 h, controlling a solid content of the slurry to be 45%, and controlling a particle size D50 of sand-milled particles to be 370 nm, so as to render a sand-milled slurry;
(3) transferring the resulting sand-milled slurry to a spray column for precursor spray granulation, a spray temperature being 300° C., selecting a two-fluid nozzle as a spray nozzle, controlling a spray pressure to be 0.8 MPa, and controlling a feeding frequency to be 20 Hz, so as to render a spray precursor of primary spherical particles; and
(4) loading the resulting spray precursor in a bowl, performing a thermal treatment in a nitrogen atmosphere, the thermal treatment including a first constant-temperature treatment and a second constant-temperature treatment, controlling a heating rate of a box type furnace to be 5° C./min, performing the first constant-temperature treatment at a temperature of 650° C. for a constant-temperature treatment duration of 2 h, performing the second constant-temperature treatment at a temperature of 850° C. for a constant-temperature treatment duration of 2 h, so as to render a sintered finished material, and sieving the finished material through a 200-mesh sieve, so as to render the lithium iron phosphate material.

### Example 7

A preparation method for a lithium iron phosphate material was provided, including steps as follows:
(1) uniformly mixing lithium carbonate, iron phosphate, a carbon source (sucrose and glucose), a fluxing material (boric acid) and water, with Li in lithium source and Fe in iron source being weighed in a molar ratio of 1.05:0.97, a mass ratio of the carbon source to iron phosphate being 0.1:1, a weight ratio of sucrose to glucose being 1:1, and a mass ratio of boric acid to iron phosphate being 0.002:1, so as to render a mixed system;
(2) performing a first grinding on the above mixed system, the first grinding being ball milling at a rotational speed of 400 r/min for 0.5 h, so as to render a primary ball-milled slurry; transferring the resulting ball-milled slurry into a sand mill for further sufficient grinding, performing sand milling at a rotational speed of 700 r/min for 1 h, controlling a solid content of the slurry to be 35%, and controlling a particle size D50 of sand-milled particles to be 300 nm, so as to render a sand-milled slurry;
(3) transferring the resulting sand-milled slurry to a spray column for precursor spray granulation, a spray temperature being 180° C., selecting a two-fluid nozzle as a spray nozzle, controlling a spray pressure to be 0.1 MPa, and controlling a feeding frequency to be 50 Hz, so as to render a spray precursor of primary spherical particles; and
(4) loading the resulting spray precursor in a bowl, performing a thermal treatment in a nitrogen atmosphere, the thermal treatment including a first constant-temperature treatment and a second constant-temperature treatment, controlling a heating rate of a box type furnace to be 5° C./min, performing the first constant-temperature treatment at a temperature of 450° C. for a constant-temperature treatment duration of 10 h, performing the second constant-temperature treatment at a temperature of 650° C. for a constant-temperature treatment duration of 10 h, so as to render a sintered finished material, and sieving the finished material through a 200-mesh sieve, so as to render the lithium iron phosphate material.

### Comparative Example 1

A preparation method for a lithium iron phosphate material was different from Example 1 in:
step (4): loading the resulting spray precursor in a bowl, performing a thermal treatment in a nitrogen atmosphere, a heating rate of the thermal treatment being 5° C./min, a temperature of the constant-temperature treatment being 750° C., and a duration of the constant-temperature treatment being 10 h.

A scanning electron microscope image of the lithium iron phosphate material in the present comparative example is as shown in FIG. 5.

### Comparative Example 2

A preparation method for a lithium iron phosphate material was different from Example 1 in:
step (4): loading the resulting spray precursor in a bowl, performing a thermal treatment in a nitrogen atmosphere, the thermal treatment including a first constant-temperature treatment and a second constant-temperature treatment, controlling a heating rate of a box type furnace to be 5° C./min, performing the first constant-temperature treatment at a temperature of 700° C. for a constant-temperature treatment duration of 6 h, performing the second constant-temperature treatment at a temperature of 600° C. for a constant-temperature treatment duration of 4 h, so as to render a sintered finished material, and sieving the finished material through a 200-mesh sieve, so as to render the lithium iron phosphate material.

### Comparative Example 3

A preparation method for a lithium iron phosphate material was different from Example 1 in that:
the fluxing material was not added in step (1).

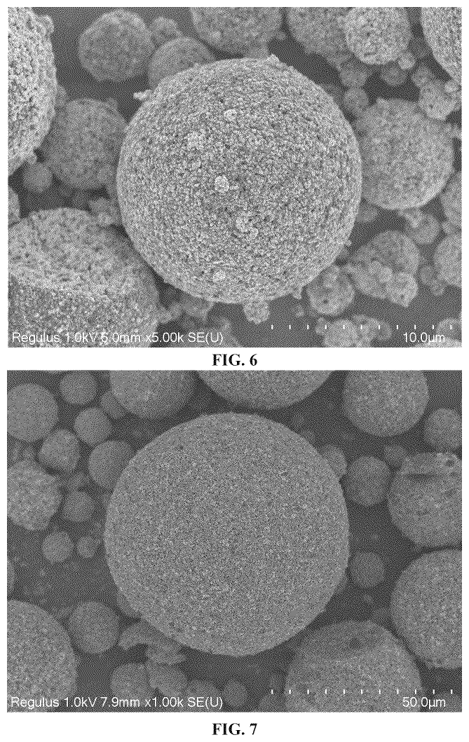

A scanning electron microscope image of the lithium iron phosphate material in the present comparative example is as shown in FIG. 6.

### Comparative Example 4

A preparation method for a lithium iron phosphate material was different from Example 1 in that:
the mass ratio of boric acid to iron phosphate in step (1) was 0.1:1.

### Comparative Example 5

A preparation method for a lithium iron phosphate material was different from Example 1 in that:
a centrifugal nozzle was used for spraying in step (3), a frequency of an atomizer was 280 Hz, and the feeding frequency was controlled to be 10 Hz.

A scanning electron microscope image of the lithium iron phosphate material in the present comparative example is as shown in FIG. 7.

### Comparative Example 6

A preparation method for a lithium iron phosphate material was different from Example 1 in that:
in step (3), the spray temperature of the spray drying was 150° C., the spray pressure was 2 MPa, and the feeding frequency was 10 Hz.

### Comparative Example 7

A preparation method for a lithium iron phosphate material was different from Example 1 in that:
in step (3), the spray temperature of the spray drying was 350° C., the spray pressure was 1.5 MPa, and the feeding frequency was 60 Hz.

### Experimental Example

### I. Performance Tests of Lithium Iron Phosphate Materials

The lithium iron phosphate materials prepared in various examples and comparative examples were respectively subjected to the following performance tests.

### 1. Compaction Density

The compaction density was tested at 3T pressure using a compaction density tester, based on GB/T 44330.

### 2. Tap Density

The tap density was tested using Quantachrome tap density meter, based on GB/T 5162.

### 3. Particle Size

The particle size was tested using a Malvern-3000 particle analyzer, based on GB/T 19077.

### 4. Specific Surface Area

The specific surface area was tested using a DX dynamic adsorption specific surface meter, based on GB/T 13390.

### 5. Resistivity

The resistivity was tested using a powder resistivity tester, based on GB/T 24521.

### 6. Particle Strength

The particle strength was tested using a dynamic ultramicroscopic hardness tester, based on GB/T 41948.

Performance tests of the lithium iron phosphate materials are as shown in TABLE 1.

TABLE 1

| | | | Particle | Specific | | |
|---|---|---|---|---|---|---|
| | Compaction | Tap | size | surface | | Particle |
| | density | density | D50 | area | Resistivity | strength |
| Group | (g/cm³) | (g/cm³) | (um) | (m²/g) | (Ω · cm) | (MPa) |
| Example 1 | 2.50 | 2.02 | 9.9 | 5.93 | 16.98 | 148.94 |
| Example 2 | 2.43 | 1.94 | 9.2 | 6.21 | 21.34 | 104.49 |
| Example 3 | 2.42 | 1.89 | 10.2 | 6.76 | 26.90 | 96.26 |
| Example 4 | 2.36 | 1.86 | 9.7 | 7.82 | 35.2 | 87.65 |
| Example 5 | 2.52 | 2.13 | 9.4 | 6.02 | 12.61 | 82.91 |
| Example 6 | 2.45 | 1.98 | 8.9 | 7.35 | 27.62 | 72.96 |
| Example 7 | 2.37 | 1.82 | 10.0 | 7.96 | 39.08 | 76.19 |
| Comparative | 2.32 | 1.80 | 8.9 | 6.84 | 48.65 | 66.72 |
| Example 1 | | | | | | |
| Comparative | 2.24 | 1.67 | 11.6 | 8.92 | 60.2 | 43.87 |
| Example 2 | | | | | | |
| Comparative | 2.28 | 1.65 | 8.5 | 10.8 | 39.48 | 67.37 |
| Example 3 | | | | | | |
| Comparative | 2.35 | 1.70 | 8.9 | 8.68 | 47.6 | 65.87 |
| Example 4 | | | | | | |
| Comparative | 2.31 | 1.42 | 13.56 | 19.27 | 56.80 | 43.80 |
| Example 5 | | | | | | |
| Comparative | 2.29 | 1.58 | 12.0 | 9.28 | 62.7 | 48.23 |
| Example 6 | | | | | | |
| Comparative | 2.36 | 1.61 | 11.4 | 8.96 | 43.9 | 52.55 |
| Example 7 | | | | | | |

It can be seen from TABLE 1 that, in the methods of various examples of the present disclosure, the fluxing material was added into the raw materials, suitable spray drying conditions and thermal treatment conditions were used, and various steps were coordinated with each other, so that the resulting lithium iron phosphate materials had high compaction density, high tap density, high particle strength, suitable D50 particle size, suitable specific surface area, and good conductivity.

Comparative Example 1 used only one constant-temperature thermal treatment, and compared with Example 1, the resulting lithium iron phosphate material had reduced compaction density and tap density, decreased particle strength, increased specific surface area, and lowered specific conductance.

Although Comparative Example 2 used two constant-temperature treatments, the temperature of the first constant-temperature treatment was higher than that of the second constant-temperature treatment, and compared with Example 1, the resulting lithium iron phosphate material had slightly reduced compaction density and tap density, decreased particle strength, and lowered specific conductance.

Comparative Example 3 did not use the fluxing material, and failed to achieve a good fluxing effect during the thermal treatment, and the resulting lithium iron phosphate material had reduced compaction density and tap density, decreased particle strength, and lowered specific conductance.

The lithium iron phosphate material obtained in Comparative Example 4 had slightly reduced compaction density and tap density, decreased particle strength, and lowered specific conductance.

Comparative Example 5 used the conventional centrifugal nozzle, and produced a large number of pores, and the resulting lithium iron phosphate material had low compaction density and tap density, remarkably decreased particle strength, and remarkably lowered specific conductance.

Conditions of the spray drying in Comparative Example 6 and Comparative Example 7 did not meet the ranges defined in the present disclosure, and the resulting lithium iron phosphate materials had slightly low compaction density and tap density, decreased particle strength, and lowered specific conductance.

### II. Battery Performance Tests

The lithium iron phosphate materials prepared in various examples and comparative examples were respectively used to prepare batteries, specifically including:
uniformly mixing the lithium iron phosphate materials, a conductive agent and a binder in a mass ratio of 90:5:5, coating mixture on an aluminum foil, and subsequently drying in a vacuum drying box at 100° C. for 10 h, to render a positive electrode plate, and cutting the obtained positive electrode plate into a circular plate with a diameter of 10 mm; using a lithium plate having a diameter of 15 mm as a negative electrode plate; and assembling the positive electrode plate, a separator, an electrolytic solution, and the negative electrode plate into a battery in a glove box. The batteries were subjected to 0.1 C charge and discharge tests at a voltage ranging from 2 V to 3.75 V.

Test results of the batteries are as shown in TABLE 2.

TABLE 2
Test Results of Batteries

| | 0.1 C charge | 0.1 C discharge | 0.1 C |
|---|---|---|---|
| | specific | specific | Coulombic |
| | capacity | capacity | efficiency |
| Group | (mAh/g) | (mAh/g) | (%) |
| Example 1 | 161.1 | 159.1 | 98.74 |
| Example 2 | 161.9 | 158.6 | 97.96 |
| Example 3 | 160.7 | 157.6 | 98.07 |
| Example 4 | 160.9 | 158.9 | 98.76 |
| Example 5 | 162.6 | 160.1 | 98.46 |
| Example 6 | 159.6 | 157.0 | 98.19 |
| Example 7 | 159.9 | 157.5 | 98.50 |
| Comparative | 161.6 | 156.5 | 96.84 |
| Example 1 | | | |
| Comparative | 158.7 | 155.6 | 98.04 |
| Example 2 | | | |
| Comparative | 158.3 | 156.2 | 98.67 |
| Example 3 | | | |
| Comparative | 157.2 | 153.7 | 97.78 |
| Example 4 | | | |
| Comparative | 160.3 | 149.2 | 93.06 |
| Example 5 | | | |
| Comparative | 159.3 | 154.6 | 97.05 |
| Example 6 | | | |
| Comparative | 155.6 | 148.6 | 95.50 |
| Example 7 | | | |

The batteries prepared with the lithium iron phosphate materials obtained in various examples of the present disclosure had high specific capacity, high Coulombic efficiency, good cycle performance, and high safety.

The batteries prepared with the lithium iron phosphate materials in Comparative Examples 1-7 had low specific capacity, and poor cycle performance.

### INDUSTRIAL APPLICABILITY

To sum up, the present disclosure provides a preparation method for a lithium iron phosphate material, a lithium iron phosphate material and use thereof. In the preparation method for a lithium iron phosphate material, by adding the suitable fluxing material into the raw materials, with suitable spray drying conditions and thermal treatment conditions, and coordination of various steps and parameter conditions, the obtained lithium iron phosphate material is enabled to have high compaction density, high tap density, high particle strength, good conductivity, and good structural stability, and processability and electrochemical performance of the material can be improved. The battery made with the lithium iron phosphate material has high specific capacity, high Coulombic efficiency, and excellent cycle performance and safety performance.

1. A preparation method for a lithium iron phosphate material, comprising steps of:
(a) performing a grinding treatment on a lithium source, an iron source, a phosphorus source, a carbon source, a fluxing material and a solvent, so as to render a mixed slurry, wherein a ratio of a total mass of the iron source and the phosphorus source to a mass of the fluxing material is 1:(0.001-0.015);
(b) performing spray drying on the mixed slurry, wherein a nozzle for the spray drying comprises a two-fluid nozzle, and the spray drying is performed at a spray temperature ranging from 180° C. to 300° C., a spray pressure ranging from 0.1 MPa to 0.8 MPa, and a feeding frequency ranging from 20 Hz to 50 Hz, so as to render a first material; and
(c) performing a thermal treatment on the first material, wherein the thermal treatment comprises a first constant-temperature treatment and a second constant-temperature treatment, a temperature T1 of the first constant-temperature treatment ranges from 450° C. to 650° C., and a temperature T2 of the second constant-temperature treatment ranges from 650° C. to 850° C.

2. The preparation method for a lithium iron phosphate material according to claim 1, comprising at least one of characteristics (1) to (2):
(1) the fluxing material comprising at least one of boric acid, calcium oxide and magnesium oxide; and
(2) a ratio of the total mass of the iron source and the phosphorus source to the mass of the fluxing material being 1:(0.002-0.01).

3. The preparation method for a lithium iron phosphate material according to claim 1, wherein the fluxing material comprises a material A and a material B, wherein the material A is boric acid, the material B is calcium oxide and/or magnesium oxide, and a mass ratio of the material A to the material B is (7-9):(1-3).

4. The preparation method for a lithium iron phosphate material according to claim 1, comprising at least one of characteristics (1) to (3):
(1) a molar ratio of the lithium source, the iron source and the phosphorous source, in terms of lithium element, iron element and phosphorous element, respectively, being (1-1.08):(0.95-1):(0.95-1);
(2) a ratio of the total mass of the iron source and the phosphorus source to a mass of the carbon source being 1:(0.03-0.15); and
(3) the carbon source comprising at least one of sucrose, glucose, starch, carbon black, polyethylene glycol and phenolic resin.

5. The preparation method for a lithium iron phosphate material according to claim 1, wherein the spray temperature of the spray drying ranges from 200° C. to 260° C., the spray pressure ranges from 0.4 MPa to 0.6 MPa, and the feeding frequency ranges from 30 Hz to 45 Hz.

6. The preparation method for a lithium iron phosphate material according to claim 1, comprising at least one of characteristics (1) to (5):
(1) a difference between the temperature T2 of the second constant-temperature treatment and the temperature T1 of the first constant-temperature treatment meeting: 180° C.≤T2−T1≤250° C.;
(2) a duration of the first constant-temperature treatment ranging from 2 h to 10 h;
(3) a duration of the second constant-temperature treatment ranging from 2 h to 10 h;
(4) a heating rate of the thermal treatment ranging from 0.5° C./min to 10° C./min; and
(5) the thermal treatment being performed under a condition of protective gas.

7. The preparation method for a lithium iron phosphate material according to claim 6, wherein the temperature of the first constant-temperature treatment ranges from 500° C. to 600° C., and the duration of the first constant-temperature treatment ranges from 3 h to 8 h; and
the temperature of the second constant-temperature treatment ranges from 700° C. to 800° C., and the duration of the second constant-temperature treatment ranges from 4 h to 8 h.

8. The preparation method for a lithium iron phosphate material according to claim 1, wherein the grinding treatment comprises a first grinding and a second grinding, wherein
a rotational speed R1 of the first grinding ranges from 300 r/min to 400 r/min, a rotational speed R2 of the second grinding ranges from 500 r/min to 700 r/min, and a ratio of the rotational speed R1 of the first grinding to the rotational speed R2 of the second grinding meets: 1.25≤R1/R2≤2;
a duration of the first grinding ranges from 0.5 h to 4 h; and
a duration of the second grinding ranges from 0.5 h to 6 h.

9. The preparation method for a lithium iron phosphate material according to claim 1, comprising at least one of characteristics (1) to (2):
(1) the mixed slurry having a solid content ranging from 20% to 60%; and
(2) the mixed slurry having a particle size D50 ranging from 200 nm to 400 nm.

10. The preparation method for a lithium iron phosphate material according to claim 1, further comprising: performing a sieving treatment on a material having undergone the thermal treatment, wherein a mesh number of the sieving treatment ranges from 180 mesh to 250 mesh.

11. A lithium iron phosphate material, prepared by the preparation method for a lithium iron phosphate material according to claim 1.

12. The lithium iron phosphate material according to claim 11, comprising at least one of characteristics (1) to (6):
(1) the lithium iron phosphate material having a compaction density ranging from 2.36 g/cm³ to 2.55 g/cm³;
(2) the lithium iron phosphate material having a tap density ranging from 1.82 g/cm³ to 2.2 g/cm³;
(3) the lithium iron phosphate material having a particle size D50 ranging from 8.6 μm to 11 μm;
(4) the lithium iron phosphate material having a specific surface area ranging from 5 m²/g to 8 m²/g;
(5) the lithium iron phosphate material having resistivity ranging from 10 Ω·cm to 39.1 Ω·cm; and
(6) the lithium iron phosphate material having particle strength ranging from 72 MPa to 160 MPa.

13. An electrode plate, comprising the lithium iron phosphate material prepared by the preparation method for a lithium iron phosphate material according to claim 1.

14. A battery, comprising the electrode plate according to claim 13.

15. An electrical device, comprising the battery according to claim 14.

16. The preparation method for a lithium iron phosphate material according to claim 2, wherein the fluxing material comprises a material A and a material B, wherein the material A is boric acid, the material B is calcium oxide and/or magnesium oxide, and a mass ratio of the material A to the material B is (7-9):(1-3).

17. The preparation method for a lithium iron phosphate material according to claim 2, comprising at least one of characteristics (1) to (3):
(1) a molar ratio of the lithium source, the iron source and the phosphorous source, in terms of lithium element, iron element and phosphorous element, respectively, being (1-1.08):(0.95-1):(0.95-1);
(2) a ratio of the total mass of the iron source and the phosphorus source to a mass of the carbon source being 1:(0.03-0.15); and
(3) the carbon source comprising at least one of sucrose, glucose, starch, carbon black, polyethylene glycol and phenolic resin.

18. The preparation method for a lithium iron phosphate material according to claim 2, wherein the spray temperature of the spray drying ranges from 200° C. to 260° C., the spray pressure ranges from 0.4 MPa to 0.6 MPa, and the feeding frequency ranges from 30 Hz to 45 Hz.

19. The preparation method for a lithium iron phosphate material according to claim 2, comprising at least one of characteristics (1) to (5):
(1) a difference between the temperature T2 of the second constant-temperature treatment and the temperature T1 of the first constant-temperature treatment meeting: 180° C.≤T2−T1≤250° C.;
(2) a duration of the first constant-temperature treatment ranging from 2 h to 10 h;
(3) a duration of the second constant-temperature treatment ranging from 2 h to 10 h;
(4) a heating rate of the thermal treatment ranging from 0.5° C./min to 10° C./min; and
(5) the thermal treatment being performed under a condition of protective gas.

20. The preparation method for a lithium iron phosphate material according to claim 2, wherein the grinding treatment comprises a first grinding and a second grinding, wherein
a rotational speed R1 of the first grinding ranges from 300 r/min to 400 r/min, a rotational speed R2 of the second grinding ranges from 500 r/min to 700 r/min, and a ratio of the rotational speed R1 of the first grinding to the rotational speed R2 of the second grinding meets: 1.25≤R1/R2≤2;
a duration of the first grinding ranges from 0.5 h to 4 h; and
a duration of the second grinding ranges from 0.5 h to 6 h.
